(19) United States
(12) Patent Application Publication
(10) Pub. No.: US 2008/0248777 A1
(43) Pub. Date: Oct. 9, 2008

(54) Apparatus and method for communicating in a high noise, multiple-recipient environment

(75) Inventors: Robert W.B. Kits van Heyningen, Portsmouth, RI (US); Ronald Paradis, Fall River, MA (US); Gail Holmes, Middletown, RI (US); Vincent J. Tarricone, Tiverton, RI (US)

Correspondence Address: THE LAW OFFICE OF JOHN T. WHELAN, L.L.C., 135 WEST DARES BEACH ROAD, SUITE 204, PRINCE FREDERICK, MD, 20678, US

(73) Assignee: KVH Industries, Inc., Middletown, RI (US)

(21) Appl. No.: 11/784,192

(22) Filed: Apr. 5, 2007

(51) Int. Cl. H04Q 7/20

(52) U.S. Cl. 455/403

(57) ABSTRACT

An apparatus and method for communicating in a high noise, multiple-recipient environment, such as a convoy or other collection of vehicles or personnel operating in adverse conditions. A plurality of user terminals is provided. For example, each vehicle in a military convoy may be provided with a user terminal. The user terminals each comprise a commercial, off-the-shelf processor capable of running a commercially available operating system and at least one software program that uses predefined icons to communicate information to other users, as described further below. Users can select a message icon by which a message corresponding to the icon may be sent to all other users. The message is sent from the user terminal to a communications control unit associated with that user terminal via a communications link. The communications control unit, among other functions, compiles the message to be sent into a desired format for transmission. From the communications control unit the message is sent via an RF modem and communications link to an RF antenna from which it is transmitted.

### FIELD OF THE INVENTION

This invention is directed to an improved apparatus and method for communicating in a high noise, multiple-recipient environment, such as a convoy or other collection of vehicles or personnel operating in adverse conditions.

### BACKGROUND OF THE INVENTION

Convoys operating in today's military environments face significant challenges in effecting simple, reliable communications between members of the convoy due to a number of factors. Constantly changing profiles of military, environmental, and strategic considerations, as well as the sheer size of many of today's convoys (often 100+ vehicles) make effective intra-convoy communications a challenging task. Such communications, however, are essential if the convoy commander is going to best protect his personnel and achieve his military objectives. That is, the commander preferably is able to send messages to members of the convoy in real time, for example, to warn of potential danger, advise of a change in orders, and/or otherwise communicate with and control the convoy.

Prior art communication systems consist of radios which do not ensure that the intended recipient actually receives and acknowledges the message. Radio-transmitted voice commands may also be garbled or not heard due to high ambient noise and other conditions competing for the recipient's attention. Communications, such as acknowledgements, from the recipient back to the sender face similar drawbacks, resulting in uncertainty as to whether or not messages have been universally received and acknowledged by members of the convoy. Military radios are also particularly expensive, often costing $8,000 or more per radio.

Hand signals also have been used to communicate in military environments, but these are easy to miss, particularly in bad weather or at night.

Accordingly, there exists a need for a system and method which effect simple, reliable and inexpensive two-way communications in a high noise, multiple-recipient environment, such as a convoy or other collection of vehicles or personnel operating in adverse conditions.

### SUMMARY OF THE INVENTION

According to a preferred embodiment of the present invention there is provided an apparatus and method for communicating in a high noise, multiple-recipient environment, such as a convoy or other collection of vehicles or personnel operating in adverse conditions. A plurality of user terminals is provided. For example, each vehicle in a military convoy may be provided with a user terminal. The user terminals each comprise a commercial, off-the-shelf processor capable of running a commercially available operating system and at least one software program that uses predefined icons to communicate information to other users, as described further below. Users can select a message icon by which a message corresponding to the icon may be sent to all other users. The message is sent from the user terminal to a communications control unit associated with that user terminal via a communications link. The communications control unit, among other functions, compiles the message to be sent into a desired format for transmission. From the communications control unit the message is sent via an RF modem and communications link to an RF antenna from which it is transmitted.

When a message transmitted in the above fashion is received by another user terminal, the recipient user terminals each get notice of receipt of the transmitted message in the form of a visual and/or audio alert. When recipients acknowledge receipt of the message, an acknowledgement message is received by a designated user, such as the commander of the convoy.

In a preferred embodiment, one communications control unit is provided for, and in electronic communications with, each user terminal. Each communications control unit communicates with its associated user terminal to provide messages to and from the user terminal and also, optionally, to provide power to the user terminal (the communications control units are, in turn, preferably powered by the vehicle in which each communications control unit is placed). Each communications control unit also comprises a radio modem and a radio modem controller, by which it may effect RF communication with other communications control units, a microprocessor board, and a power board. The radio modem is in electronic communication with an RF antenna which may be located within or outside the vehicle, as will be apparent to those skilled in the art.

In operation, when a message is to be sent from a user terminal, the sender selects the desired message (or messages) from a plurality of icons provided on a graphical user interface of the user terminal. A desired message is selected by the sender, such as by pressing the message icon with the user's finger or a pointer or “clicking on” the message icon using a remote control or the like. The message is sent by the user terminal to its corresponding communications control unit which, in turn, transmits the message through the RF modem over a communications link to an RF antenna to the other user terminals in the convoy. Upon receipt of the message by the other user terminals, an audio and/or visual message is provided to the receiving user terminal indicating that a particular message has been received. When the recipient of the message acknowledges its receipt, such as by touching or clicking on an acknowledgement icon, an acknowledge message is received by a selected user terminal, such as that of the unit commander, in the manner described above.

Additional features and advantages of the present invention are described in and will be apparent from, the following Detailed Description of the Invention and the figures.

### BRIEF DESCRIPTION OF THE DRAWINGS

FIG. 1 is a system diagram of the present invention illustrating an exemplary user terminal, communications control unit, and RF antenna of the present inventions.

FIG. 2 is a logical diagram showing various components of the communications control unit illustrated in FIG. 1.

FIG. 3 is a table depicting information relating to various fields comprising messages sent to and from the user terminals in accordance with the present invention.

FIG. 4 is an additional illustration of a user terminal in accordance with the present invention.

### DETAILED DESCRIPTION OF THE INVENTION

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that although the terms first and second are used herein to describe various elements, these elements should not be limited by these terms. These terms are only used to distinguish one element from another element. As used herein, the term “and/or” includes any and all combinations of one or more of the associated listed items. The symbol “/” is also used as a shorthand notation for “and/or”.

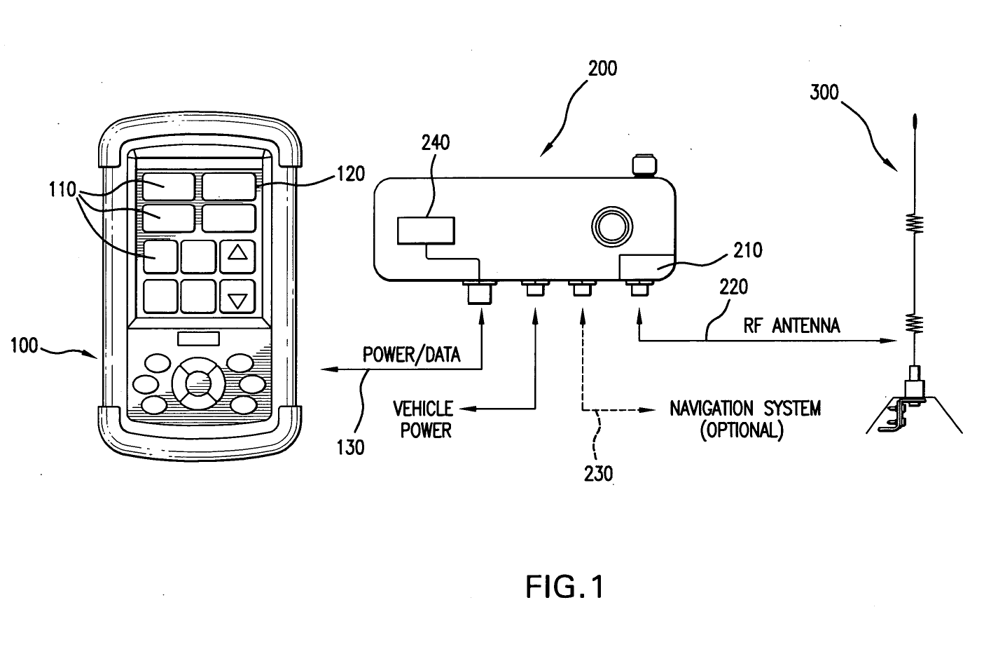

As illustrated in FIG. 1, an apparatus and method for communicating in a high noise, multiple-recipient environment in accordance with the present invention are provided. Specifically, there is shown in FIG. 1 a preferred exemplary embodiment of a user terminal 100. Each user terminal 100 comprises a commercial, off-the-shelf processor (not shown), such as a PocketPC or the like. The processor in each user terminal 100 is capable or running commercial, off-the-shelf operating system software, such as Microsoft Windows Mobile 2003 or the like, as well as the same or additional software to effect communications between user terminals. Each user terminal 100 is provided with a plurality of message icons 110 arranged on a graphical user interface (GUI) 120 of the user terminal. Message icons 110 provide a visual indication (through text, iconic images, or the like) to the user of the user terminal 100 of the message corresponding to that particular message icon 110. Examples of message icons 110 to be used in communications between convoy members in a military environment may include, for example, text and/or images indicative of the following messages: “ambush”, “threat alert”, “gas warning”, “enemy alert”, “blackout drive”, “buzzer on/off”, “break contact”, “cease fire”, “open interval”, “close interval”, “maintain interval”, “convoy halt”, “turn left”, “turn right”, “rally point”, “maintain speed”, “maintenance failure”, “check point”, and “stopped vehicle”. Of course, additional or other message icons 110 may also be provided on user terminals 100 depending on the application and environment in which the communications are required, as will be apparent to those skilled in the art.

GUI 120 may display additional information to the user as well. For example, GUI 120 may include a navigation bar or the like (not shown) indicating the position, heading, and RF signal strength of the user terminal 100. GUI 120 may also provide a visual indication of what messages have been sent and received by which user terminals 100, as discussed further below.

In accordance with the present invention, the message icons 110 are preferably prioritized into messages of higher and lower priority. For example, messages icons 100 that may be classified as the highest priority may include those associated with “ambush”, “threat alert”, “enemy alert”, and similar messages, while messages such as “stopped vehicle” or “check point” may be classified as lower priority messages. In operation, higher priority messages may be handled differently than lower priority messages. For example, higher priority messages may be transmitted at a higher data rate than lower priority messages. In addition, higher priority messages may preferably be transmitted using only a single step, such as pressing once the message icon 110 corresponding to the desired message. Lower priority messages, on the other hand, may be sent only after the user first presses on the message icon 110 corresponding to the desired message and subsequently confirms his intent to send the message, such as by responding to a user prompt displayed on GUI 120.

Higher priority messages also may be received differently than lower priority messages. That is, for example, upon receipt of a higher priority message, a user terminal 100 may provide an audio (such as a tone or alarm), visual (illuminated or blinking message icon 110, and/or physical (such as vibration) indication to the user that a high priority message has been received. Alternatively, the entire GUI 120 may flash or vibrate or otherwise visually, physically, or audibly indicate to the user that a high priority message has been received by user terminal 100. Upon the receipt of lower priority messages, on the other hand, user terminal 100 may provide different or fewer indications of the receipt of the message. By providing different indications that a message is received as a function of the priority of the underlying received message, a user of the user terminal 100 may quickly learn to distinguish higher priority messages from lower priority messages, thus enabling the user to in turn prioritize his review and acknowledgement of the message, a luxury not heretofore available in the military environment.

High priority messages may also be acknowledged in different ways by operators of the user terminals 100. For example, a high priority message such as “ambush” may be acknowledged quickly and simply such as in a verbal or other hands-free fashion by the recipient using voice recognition software. Alternatively, an acknowledgment message may be initiated in other ways, such as by touching any portion of GUI 120. Lower priority messages, on the other hand, may be acknowledged by pressing or clicking on an “acknowledgement message” icon 110.

Each user terminal 100 also is provided with software (not shown) that is executed by the processor located in each user terminal. The software may, among other functions, be used to filter messages received by the user terminal 100 as a function of, for example, the priority or other characteristic of the received message. (Such other characteristics may include, for example, the identity of the sender of the message, the time-stamp of the message, and the geographic location from which the message was sent.) More specifically, when a user terminal is turned on, the user of that terminal may be prompted, via GUI 120, to input the vehicle type (for example, “commander”, “lead”, “recovery”, “protection platform”, “task”, and the like) and/or vehicle ID of the vehicle in which that user terminal 100 is present. Based on that input, and/or other parameters, the software in each user terminal 100 may be configured to filter out certain messages received by that user terminal. For example, “acknowledgment messages” (like all messages) are received by all user terminals, but may be filtered such that they are passed for display view by only the user terminal 100 of the unit commander.

Each user terminal 100 also comprises a memory (not shown) in which may be stored a log file of all messages sent and received by that user terminal. The memory of each user terminal 100 may be accessed and/or downloaded by conventional means, as will be understood by those skilled in the art, thus enabling effective post-event analysis as regards the communications sent and received by user terminals 100 within the convoy.

As further shown in FIG. 1, there is also provided a communications control unit 200. Preferably, one communications control unit 200 is provided for and in geographic proximity (such as in the same vehicle) with each user terminal 100. Communications control unit 200 is coupled in electronic communication, such as by cable or wirelessly, to its corresponding user terminal 100 via communications link 130. Communications control unit 200 transmits data to and receives data from user terminal 100 over communications link 130. Preferably, each communications control unit 200 also provides power to its corresponding user terminal 100 over communications link 130, as also shown in FIG. 1. Alternatively, user terminal 100 may be powered separately or supplementally by any of a number of known power sources, such as a battery pack or the like. Communications control units 200 are in turn preferably powered by vehicles in which they are mounted.

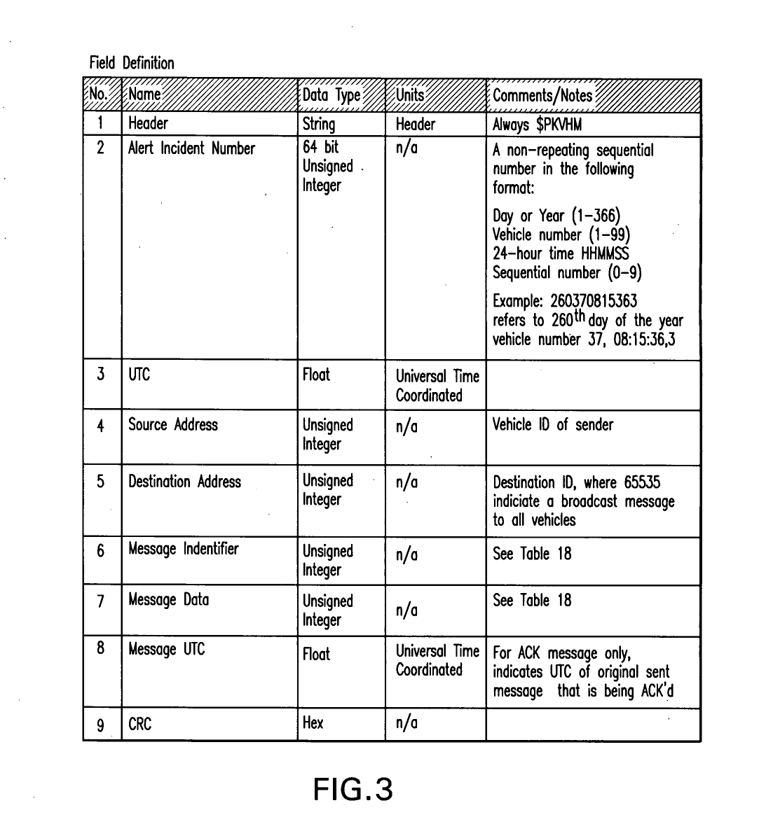

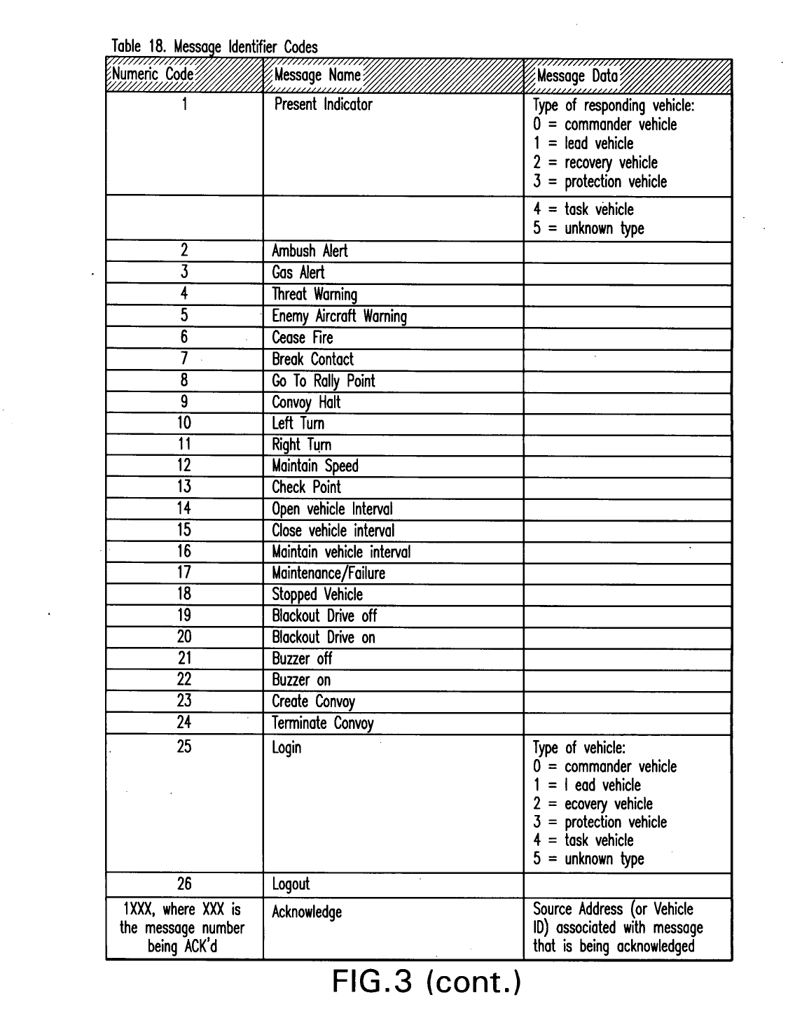

Communications control units 200 may optionally be connected to an externally provided navigation system or the like (not shown) via communications link 230, as also shown in FIG. 1. Through such a navigation system, the location, heading, and other such information of the vehicle may be provided via communications control unit 220 and communications link 130 to user terminal 100. In this manner, the location of a given user terminal 100 may be appended to any message sent by that user terminal in a manner discussed in more detail herein, as discussed further in connection with FIG. 3, thus providing to user terminals 100 receiving such a message not only the content of the message itself but also the location of the user terminal 100 from which the message was sent. This feature is particularly useful, such as in the event of transmitting an “ambush” alert in which the location of the sending user terminal is paramount.

FIG. 1 also illustrates an RF antenna 300. RF antenna 300 is electronically coupled to RF modem 210 by means of communications link 220.

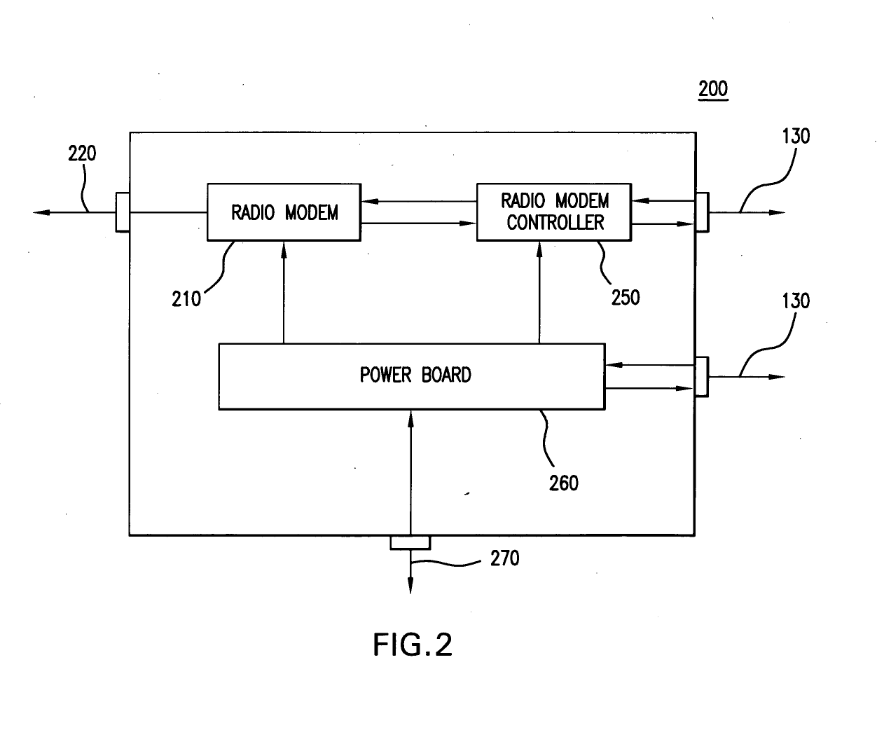

FIG. 2 illustrates various components of communications control unit 200. As shown therein, communications control unit 200 comprises a radio modem 210, a radio modem controller 250, a power board 260, and a processor and memory (not shown). Radio modem 210 may be of known configuration suitable to modulate and demodulate signals for RF communications. Radio modem 210 is provided with messages to send and is controlled by radio modem controller 250 to control, for example, the frequency at which radio modem 210 operates, any encryption and decryption to be performed, and the like. Radio modem controller 250 also formats messages received from user terminal 100 in a manner suitable for transmission and reformats messages received from RF antenna 300 via radio 210 in a manner suitable for display on the GUI 120 of the user terminal 100. Radio modem 210 and radio modem controller 250 are powered by power board 260 which, in turn, preferably is provided power via power link 270 from an external source such as the vehicle in which communications control unit 200 is mounted or the like.

As further shown in FIG. 2, the RF signals output by radio modem are passed by communications link 220 to RF antenna 300. Similarly, messages to and from user terminal 100 are received by and sent from radio modem controller 250 by means of communications link. Navigation, GPS and/or other location information may be provided to communications control unit 200 via navigation link from any of a variety of known conventional sources of such information.

In operation, a user may select a desired message to send to other user terminals 100. Accordingly, any member of the convoy can provide alerts (of any priority) to other user terminals 100 to warn their comrades of a threat or other condition of concern. Transmission of the message is effected by first identifying the message icon 110 on GUI 120 that corresponds to the desired message. The user next presses or clicks on (or takes other steps) necessary to trigger transmission of the message corresponding to that message icon 110. User terminal 100 then appends to the message to be sent certain header information. The header information, a preferred embodiment of which is depicted in FIG. 3, may include, for example, one or more of the following fields: the day of the year (1-366), vehicle number, 24 hour time in HHMMSS format, the vehicle ID of the sender, the destination user terminal, etc. Of course, other header information may also be included as will be apparent to those skilled in the art.

The message is then passed from the user terminal 100 via communications link 130 to radio modem controller 250 of communications control unit 200. Radio modem controller 250 formats the received message in a manner suitable for transmission, including, for example, appending to the message the various fields described and depicted in FIG. 3. Radio modem controller 250 then passes the reformatted message via RF modem 210 and communications link 220 to RF antenna 300. In this manner, messages are transmitted at radio frequency to all other user terminals 100 that are (i) tuned to the proper RF frequency, (ii) within range of the transmitting user terminal 100, and (iii) in compliance with any line-of-sight restrictions of the transmitting user terminal.

Messages may be encrypted by user terminal 100 and/or communications control unit 200 prior to transmission and decrypted upon reception, as will be readily understood by those of ordinary skill in the art.

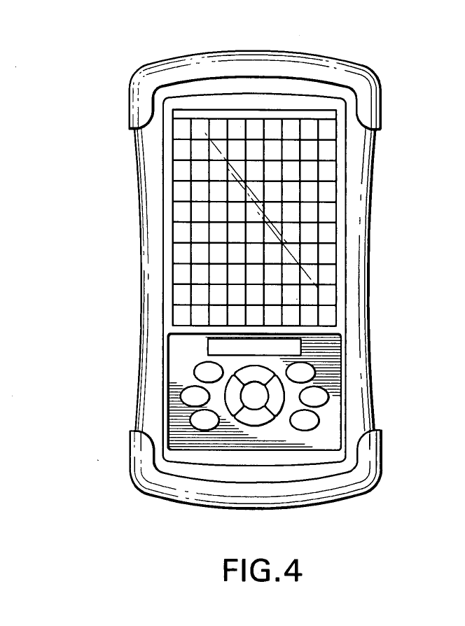

FIG. 4 is a second illustration of a user terminal 100 in accordance with the present invention. As shown in FIG. 4, in addition to or in lieu of the message icons 110 the GUI 120 of a user terminal 100 may also comprise a visual indication of the location and status of all other user terminals 100. For example, the user terminal 100 of the commander of a convoy may have a GUI 120 that is more populated and/or differently populated than the GUI 120 of other user terminals, as controlled by software resident in user terminal 100. Alternatively, the GUI 120 may be changed or amended by the user as a function of what information the user wants to have displayed at a given time. As illustrated in FIG. 4, one example of a GUI 120 for a commander's user terminal 100 in accordance with the present invention may be a “bingo screen” formant which provides an instant assessment of convoy status, which user terminals 100 have or have not acknowledged a message, and where each user terminal 100 is located relative to each other user terminal. As a result, true convoy-wide situational awareness is available in the field.

It will be appreciated that the apparatus and operations described above are illustrative examples, and that other architectures and operations fall within the scope of the present invention. For example, while the present invention has been described herein primarily in the context of communications within military convoys, the invention is not limited so such application. Examples of other applications contemplated for use with the present invention include communications within large warehouse complexes that need to direct many trucks to different loading bays in real time and receive feedback that a particular truck is in the area and that the truck has received a message or messages sent to it. More generally, in the drawings and specification, there have been disclosed exemplary embodiments of the invention. Although specific terms are employed, they are used in a generic and descriptive sense only and not for purposes of limitation, the scope of the invention being defined by the following claims.

What is claimed is:

1. A communications system comprising:
a plurality of user terminals, each user terminal having at least one processor and a graphical user interface;
a plurality of message icons provided on the graphical user interface of each of said user terminals, each of said plurality of message icons corresponding to a message to be transmitted by said user terminal;
a plurality of communications control units in electronic communications with said plurality of user terminals, said plurality of communications control units being capable of receiving data indicative of a message corresponding to said plurality of message icons; and
a plurality of RF antennas in electronic communications with said plurality of communications control units,
wherein when one of said plurality of message icons on a user terminal is selected by a user, data corresponding to a message corresponding to said selected message icon sent by that user terminal to a corresponding communications control unit and by that corresponding communications control unit to a corresponding RF antenna for transmission to the other of said plurality of user terminals.

2. A communications system according to claim 1, wherein one communications control unit is provided for each of said plurality of user terminals.

3. A communications system according to claim 1, wherein one RF antenna is provided for each of said plurality of communications control units.

4. A communications system according to claim 1, wherein at least one said plurality of message icons comprises an acknowledgement message icon.

5. A communications system according to claim 1, where each of said plurality of user terminals comprises a memory for storing information relating to messages transmitted and received by said user terminal.

6. A communications system according to claim 1, wherein the graphical user interface of at least one of said plurality of user terminals depicts a status of each of said other user terminals.

7. A communications system according to claim 1, wherein said plurality of message icons correspond to messages of varying priority, and further wherein transmission of said messages differs as a function of said priority.

8. A user terminal for transmitting and receiving messages to other user terminals comprising:
at least one processor;
software capable of being executed on said at least one processor;
a graphical user interface, controlled by said software and comprising a plurality of message icons thereon, each of same plurality of message icons providing to a user of said user terminal a visual indication of a message capable of being transmitted by said user terminal corresponding to that message icon; and
a memory for storing information relating messages transmitted and received by said user terminal;
wherein said plurality of message icons correspond to messages of varying priority, and further wherein transmission of said messages differs as a function of said priority.

9. A user terminal according to claim 8, wherein at least one of said plurality of message icons comprises an acknowledgement message icon.

10. A user terminal according to claim 8, wherein the graphical user interface is capable of being configured by said software to depict a status of each of said other user terminals.

11. A user terminal according to claim 8, wherein messages received by said user terminal are selectively displayed on said graphical interface as a function of said priority.
